(19) United States
(12) Patent Application Publication
(10) Pub. No.: US 2024/0149608 A1
(43) Pub. Date: May 9, 2024

(54) HIDDEN PATTERNED STRUCTURE AND ELECTRONIC VAPORIZATION DEVICE

(71) Applicant: SHENZHEN SMOORE TECHNOLOGY LIMITED, Shenzhen (CN)

(72) Inventors: Jicong CHEN, Shenzhen (CN); Zhanhui SUN, Shenzhen (CN); Yu LIU, Shenzhen (CN); Shunjie LIN, Shenzhen (CN); Feng XU, Shenzhen (CN)

(21) Appl. No.: 18/500,276

(22) Filed: Nov. 2, 2023

(30) Foreign Application Priority Data
Nov. 4, 2022 (CN) 202222963068.2

(51) Int. Cl. B44F 1/14; A24F 40/10

(52) U.S. Cl. CPC B44F 1/14; A24F 40/10

(57) ABSTRACT

A hidden patterned structure, applicable to an electronic vaporization device, includes: a base surface; and a plurality of patterned cells protruding from the base surface. Each patterned cell of the plurality of patterned cells includes at least two chamfered surfaces, the at least two chamfered surfaces being at different angles relative to the base surface. At least one patterned surface is formed on at least one chamfered surface of the at least two chamfered surfaces of at least a portion of the plurality of patterned cells. The at least one patterned surface has a different surface roughness and/or is at a different height from a chamfered surface corresponding to the at least one patterned surface.

### CROSS-REFERENCE TO PRIOR APPLICATION

Priority is claimed to Chinese Patent Application No. 202222963068.2, filed on Nov. 4, 2022, the entire disclosure of which is hereby incorporated by reference herein.

### FIELD

The present application relates to the field of electronic vaporization devices, and more specifically, to a hidden patterned structure and an electronic vaporization device.

### BACKGROUND

With the development of science and technology and the pursuit of fashion, the surface treatment of electronic vaporization products on the market is single and rigid, and patterns are straightforward, which cannot meet the increasingly high requirements of consumers for the appearance of products.

A hidden patterned design is a design that can make three-dimensional patterns present multiple visual changes. In the prior art, a product with a hidden patterned design is generally produced by micro-carving and transfer printing. In the product, a reflective inclined plane with a patterned design is arranged among a plurality of protruding parts arranged in a continuous matrix, and the reflective inclined plane is used as a reflection angle to refract light rays to make the pattern appear, for example, a hidden pattern on a coin. A user may rotate the coin to observe the hidden pattern from different angles, but this engraving technology is limited by the reflective characteristics of the material, which makes it impossible to be widely used in products made of various materials, and its application range is not wide and its versatility is not strong.

### SUMMARY

In an embodiment, the present invention provides a hidden patterned structure, applicable to an electronic vaporization device, comprising: a base surface; and a plurality of patterned cells protruding from the base surface, wherein each patterned cell of the plurality of patterned cells comprises at least two chamfered surfaces, the at least two chamfered surfaces being at different angles relative to the base surface, wherein at least one patterned surface is formed on at least one chamfered surface of the at least two chamfered surfaces of at least a portion of the plurality of patterned cells, and wherein the at least one patterned surface has a different surface roughness and/or is at a different height from a chamfered surface corresponding to the at least one patterned surface.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic diagram of a three-dimensional structure of an electronic vaporization device according to some embodiments of the present application when viewed in a first direction;

FIG. 2 is a schematic diagram of a three-dimensional structure of the electronic vaporization device shown in FIG. 1 when viewed in a second direction;

FIG. 3 is a schematic diagram of a cross-sectional structure of the electronic vaporization device shown in FIG. 1; and

FIG. 4 is a schematic diagram of a three-dimensional structure of a battery shell in FIG. 1.

### DETAILED DESCRIPTION

In an embodiment, the present invention provides a hidden patterned structure and an electronic vaporization device having the hidden patterned structure for the forgoing defects in the prior art.

In an embodiment, the present invention provides a hidden patterned structure, applicable to an electronic vaporization device, and including a base surface and a plurality of patterned cells protruding from the base surface. Each of the patterned cells includes at least two chamfered surfaces, the at least two chamfered surfaces are at different angles relative to the base surface, at least one patterned surface is formed on at least one of the chamfered surfaces of at least a portion of the patterned cells, and the patterned surface has a different surface roughness and/or is at a different height from the chamfered surface corresponding to the patterned surface.

In some embodiments, at least two patterned surfaces are formed on each of the at least two chamfered surfaces at different angles of at least a portion of the patterned cells.

In some embodiments, the base surface is a plane, a cylindrical surface, or a regular cambered surface. In some embodiments, the plurality of patterned cells are arranged in a continuous rectangular array.

In some embodiments, the patterned cell is in the shape of a strip, a sphere, a cylinder, a truncated cone, or a polyhedron.

In some embodiments, the patterned surface is dot-shaped, linear, or planar.

In some embodiments, the size of the patterned surface is in a range of 50 microns to 200 microns.

In some embodiments, a distance between two adjacent patterned surfaces is in a range of 100 microns to 300 microns. In some embodiments, an included angle between the chamfered surface and the base surface is in a range of 1 degree to 89 degrees. The present application further provides an electronic vaporization device, including a housing, where at least one outer surface of the housing is provided with the hidden patterned structure as described in any one of the above.

Implementation of the present application has at least the following beneficial effects: The pattern of the hidden patterned structure of the present application is presented by combining the angle of the chamfered surface, the angle of the patterned surface, and reflection of a light ray, which, in combination, present a multiplying ever-changing state. In addition, the hidden patterned structure has no requirements for reflection of the body material and therefore is not affected by the body material, is applicable to various materials, and can be machined flexibly, which facilitates mass production.

In order to have a clearer understanding of the technical features, the objectives, and the effects of the present application, specific implementations of the present application are now described in detail with reference to the accompanying drawings.

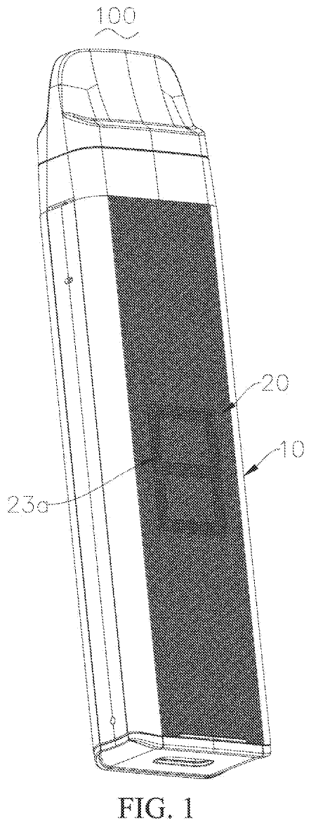

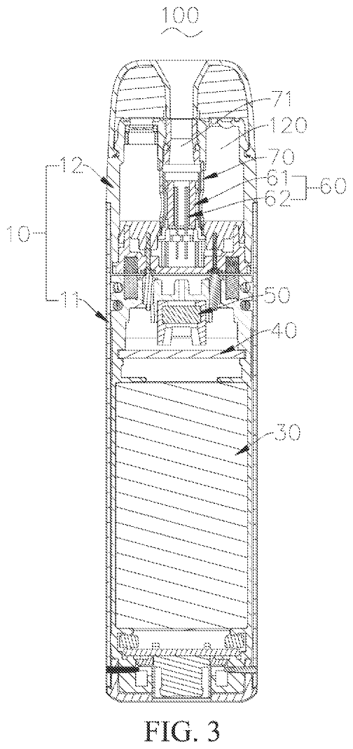

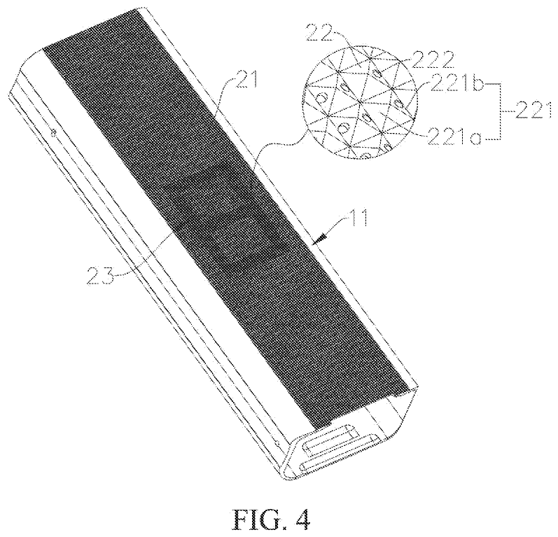

FIG. 1 to FIG. 4 show an electronic vaporization device 100 according to some embodiments of the present application. The electronic vaporization device 100 may be configured to accommodate a vaporizable solid or liquid medium and heat and vaporize the vaporizable medium to generate aerosol. In this embodiment, the electronic vaporization device 100 may be substantially in the shape of a square column. In another embodiment, the electronic vaporization device 100 is not limited to being in the shape of a square column, or may be in another shape such as a column, an ellipse, or a flat column.

The electronic vaporization device 100 generally includes a housing 10, a heating assembly 60 accommodated in the housing 10, and a control circuit configured to control heating of the heating assembly 60. The heating assembly 60 generates heat after being energized, so as to heat and vaporize the vaporizable medium.

An outer surface of a side of the housing 10 may be provided with a hidden patterned structure 20. The hidden patterned structure 20 includes a base surface 21 and a plurality of patterned cells 22 protruding from the base surface 21. Each of the patterned cells 22 has at least two chamfered surfaces 221. The at least two chamfered surfaces 221 are at different angles relative to the base surface 21. At least one patterned surface 222 is formed on at least one of the chamfered surfaces 221 of at least a portion of the patterned cells 22, to form at least one pattern 23 in combination. The patterned surface 222 has a different surface roughness and/or is at a different height from the chamfered surface 221 corresponding to the patterned surface, so that different patterned effects can be observed when the hidden patterned structure 20 is viewed from different angles, effectively improving the texture and sense of science and technology of the product, enhancing the unique labeling of the product, and increasing the added value of the product. In addition, the hidden patterned structure 20 has no requirements for reflection of the body material and therefore is not affected by the body material, is applicable to various materials, such as stainless steel, zinc alloy, aluminum alloy, and plastic, and has a wide application range and strong practicability. Further, at least two patterned surfaces 222 are formed on at least two chamfered surfaces 221 to form at least two patterns 23 in combination, so that when the hidden patterned structure 20 is viewed from different angles of view, at least two patterns 23 can be displayed, thereby generating variability of different patterns and achieving the display effect of multiple hidden patterns. It may be understood that in another embodiment, the hidden patterned structure 20 may also be arranged on two or more surfaces of the housing 20, or may be arranged on a surface of another component of the electronic vaporization device 100.

The base surface 21 may be a plane, a cylindrical surface, or a regular cambered surface. The patterned cell 22 may be in various shapes such as the shape of a strip, the shape of a sphere, the shape of a cylinder, the shape of a frustum of a cone, and the shape of a polyhedron. The shape of the polyhedron may include the shape of a pyramid or the shape of a pyramidal frustum, for example, the shape of a pyramid, the shape of a triangular pyramid, the shape of a quadrangular pyramid, the shape of a pentagonal pyramid, and the shape of a hexagonal pyramid. The plurality of patterned cells 22 may be arranged in a continuous or discontinuous array, and a higher distribution density of the patterned surfaces 222 on the plurality of patterned cells 22 leads to a better patterned effect. Generally, a distance between two adjacent patterned surfaces 222 may be in a range of 100 microns to 300 microns. The shape of the patterned surface 222 may be in the shape of a point, a line, or a plane. The shape of the patterned surface 222 may be in the shape of a point, a line, or a plane. The smaller sizes (the sizes of the length, the width, the diameter, and the like) of the patterned surface 222 lead to a more exquisite presented pattern, and the smallest size of the patterned surface 222 may reach 50 microns. The size of the patterned surface 222 may not be too large, otherwise the presented pattern is rough, and generally, the size of the patterned surface may not exceed 200 microns.

Specifically, in this embodiment, the housing 10 includes a battery shell 11 and a vaporization shell 12 detachably or non-detachably arranged above the battery shell 11 in the longitudinal direction. The hidden patterned structure 20 is arranged on an outer surface of a side of the battery shell 11. The base surface 21 is a plane, and the plurality of patterned cells 22 are arranged in a continuous rectangular array. The plurality of patterned cells 22 have the same shape and size, thereby facilitating machining and manufacturing.

Each patterned cell 22 is a regular quadrangular pyramid and has four chamfered surfaces 221. Two patterned surfaces 222 are formed on each of the two chamfered surfaces 221 at different angles of part of the patterned cell 22, so that two different patterns 23 can be displayed when the hidden patterned structure is viewed from different perspectives. It may be understood that when the patterned cell 22 is a polyhedron, the patterned surface 222 may be arranged on part or all of the chamfered surfaces 221 of the patterned cell 22, so that a plurality of patterns can be displayed.

For ease of description, in this embodiment, the two chamfered surfaces 221 are respectively marked as a first chamfered surface 221a and a second chamfered surface 221b, and the first chamfered surface 221a and the second chamfered surface 221b are two surfaces arranged on the patterned cell 22 opposite to each other. The two patterns 23 are respectively marked as a first pattern 23a and a second pattern 23b. The first pattern 23a and the second pattern 23b are respectively formed by combining the patterned surface 222 on the first chamfered surface 221a and the patterned surface 222 on the second chamfered surface 221b. For the first chamfered surface 221a viewed from a direction, the first pattern 23a formed by the patterned surface 222 in this direction is displayed, and the second pattern 23b on the second chamfered surface 221b is hidden. For the second chamfered surface 221b viewed from another direction, the second pattern 23b formed by the patterned surface 222 in this direction is displayed, and the first pattern 23a on the first chamfered surface 221a is hidden. In addition, when observed from different angles, the first pattern 23a and the second pattern 23b may also present different results. For example, under certain light rays, the first pattern 23a is presented in a dark color when the hidden patterned structure is rotated to the right by 30 degrees, the first pattern 23a is presented in a bright color when the hidden patterned structure is rotated to the right by 60 degrees, the second pattern 23b is presented in a dark color when the hidden patterned structure is rotated to the left by 30 degrees, and the second pattern 23b is presented in a bright color when the hidden patterned structure is rotated to the left by 60 degrees.

In addition, the pattern of the hidden patterned structure 20 is presented by combining the angle of the chamfered surface, the angle of the patterned surface, and reflection of a light ray, which, in combination, present a multiplying ever-changing state, thereby achieving the display effect of multiple hidden and ever-changing patterns and embodying more exquisite and mysterious multi-level variability. For example, under certain light rays, the first pattern 23a is presented in a dark color when the hidden patterned structure is rotated to the right by 30 degrees, the first pattern 23a is presented in a bright color when the hidden patterned structure is rotated upward by 15 degrees, and the first pattern 23a is presented in the dark color again when the hidden patterned structure is rotated upward by 15 degrees. This is the contrast presented by the combination of the angle of the chamfered surface and the angle of the patterned surface. For another example, under certain light rays, the first pattern 23a is presented in a dark color when the hidden patterned structure is rotated to the right by 30 degrees, and under changing light rays, the first pattern 23a alternates between a dark color and a bright color during a 180-degree in-situ rotation of the hidden patterned structure.

In this embodiment, the patterned surface 222 is a circular concave surface formed by recessing the first chamfered surface 221a and the second chamfered surface 221b. In another embodiment, alternatively, one of the first chamfered surface 221a and the second chamfered surface 221b may be recessed to form the patterned surface 222, and the other may protrude from the patterned surface 222. Alternatively, the patterned surface 222 may also be a convex surface formed by protruding the first chamfered surface 221a and the second chamfered surface 221b. The shape of the patterned surface 222 is not limited to a circle, which may be various regular or irregular shapes such as an ellipse or a square. In some other embodiments, the patterned surface 222 may also be a rough surface or a smooth surface that is in contrast with the first chamfered surface 221a and the second chamfered surface 221b.

When an included angle between the chamfered surface 221 and the base surface 21 is in a range of 1 degree to 89 degrees, hidden and ever-changing patterns can be presented. When the included angle is in a range of 1 degree to 30 degrees, the visible visual angle range is small, and the front view is basically invisible. When the included angle is in a range of 60 degrees to 89 degrees, the visible visual angle range is large, and the front view is visible. When the included angle is in a range of 30 degrees to 60 degrees, the visible visual angle range is in the middle, and the front view is looming. The chamfered surfaces 221 at different angles may be selected based on the effect required by the product. In addition, when the patterned surface 222 is closer to the bottommost part of the chamfered surface 221 (that is, closer to the base surface 21), the visual angle range is smallest. The visual angle range is the angle of the chamfered surface 221. For example, if the angle of the chamfered surface 221 is 60 degrees, the visual angle is 120 degrees. When the patterned surface 222 is closer to the top of the chamfered surface 221 (that is, farther away from the base surface 21), the visual angle range is largest. The visual angle range is closest to 180 degrees.

The hidden patterned structure 20 can be machined flexibly, which facilitates mass production, has high machining precision, high efficiency, and low costs, and can be obtained through the precise manufacturing technology. In an embodiment, the hidden patterned structure 20 may be presented on the surface of the product through numerical control machining (CNC). For example, a diamond cutter with a specific angle may be used to machine the chamfered surface 221 through CNC on the surface of the product according to the design drawing, and the patterned cell 22 is divided by the chamfered surface 221. Then, the patterned surface 222 is machined through CNC on the chamfered surface 221. In another embodiment, the hidden patterned structure 20 may also be directly applied to a mold, which can be realized in molding manners such as injection molding, die pressing, and die casting. For example, a chamfered surface 221 and a patterned surface 222 are machined on the surface of the mold by arc discharge, etching, laser engraving, and laser.

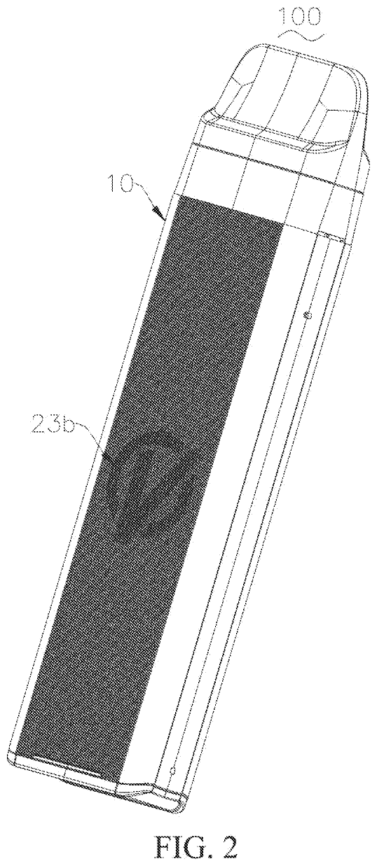

As shown in FIG. 2 again, the electronic vaporization device 100 in this embodiment is configured to accommodate and heat a vaporizable liquid medium, and an accommodating cavity 120 for accommodating the liquid vaporizable medium is formed in a vaporization shell 12. A heating assembly 60 is arranged in the vaporization shell 12 and is in fluid communication with the accommodating cavity 120. A vent tube 70 may further be arranged in the vaporization shell 12 in the longitudinal direction, and the inner wall surface of the vent tube 70 defines an air outlet channel 71 for outputting aerosol formed through vaporization by the heating assembly 60.

The heating assembly 60 may include a liquid absorbing element 61 for absorbing the vaporizable liquid medium from the accommodating cavity 120 and a heating element 62 in contact with the liquid absorbing element 61. The liquid absorbing element 61 is made of a porous material, such as liquid absorbing cotton or porous ceramics. Further, in this embodiment, the heating assembly 60 may be accommodated at the lower end of the vent tube 70, the liquid absorbing element 61 is in the shape of a circular tube, and the heating element 62 is arranged on the inner surface of the liquid absorbing element 61.

The electronic vaporization device 100 may further include a battery 30, a circuit board 40, and an airflow sensing element 50 accommodated in a battery shell 11. The battery 30 is configured to supply power to the heating element 62, and the circuit board 40 is applicable to relevant control circuits to be arranged. The airflow sensing element 50 is electrically connected to the control circuit, and can sense the change of airflow when a user sucks to generate a suction signal. The suction signal may be transmitted to the control circuit to start the electronic vaporization device 100.

It may be understood that in another embodiment, the electronic vaporization device 100 may also be configured to vaporize a vaporizable solid medium, for example, to bake and heat a cylindrical vaporizable medium inserted therein at a low temperature, so as to release the aerosol extract in the vaporizable medium in a non-burning state.

It may be understood that the foregoing technical features can be used in any combination without limitation.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A hidden patterned structure, applicable to an electronic vaporization device, comprising:
a base surface; and
a plurality of patterned cells protruding from the base surface,
wherein each patterned cell of the plurality of patterned cells comprises at least two chamfered surfaces, the at least two chamfered surfaces being at different angles relative to the base surface,
wherein at least one patterned surface is formed on at least one chamfered surface of the at least two chamfered surfaces of at least a portion of the plurality of patterned cells, and
wherein the at least one patterned surface has a different surface roughness and/or is at a different height from a chamfered surface corresponding to the at least one patterned surface.

2. The hidden patterned structure of claim 1, wherein at least two patterned surfaces are formed on each of the at least two chamfered surfaces at different angles of at least a portion of the plurality of patterned cells.

3. The hidden patterned structure of claim 1, wherein the base surface comprises a plane, a cylindrical surface, or a regular cambered surface.

4. The hidden patterned structure of claim 1, wherein the plurality of patterned cells are arranged in a continuous rectangular array.

5. The hidden patterned structure of claim 1, wherein each patterned cell is in a shape of a strip, a sphere, a cylinder, a truncated cone, or a polyhedron.

6. The hidden patterned structure of claim 1, wherein the at least one patterned surface is in a shape of a point, a line, or a plane.

7. The hidden patterned structure of claim 1, wherein a size of the at least one patterned surface is in a range of 50 microns to 200 microns.

8. The hidden patterned structure of claim 1, wherein a distance between two adjacent patterned surfaces of the at least one patterned surface is in a range of 100 microns to 300 microns.

9. The hidden patterned structure of claim 1, wherein an included angle between the chamfered surface and the base surface is in a range of 1 degree to 89 degrees.

10. An electronic vaporization device, comprising:
a housing,
wherein at least one outer surface of the housing is provided with the hidden patterned structure of claim 1.
